(19) United States
(12) Patent Application Publication
(10) Pub. No.: US 2026/0348449 A1
(43) Pub. Date: Nov. 5, 2026

(54) COUPLING FOR SPLICING CABLE AND WIRE ROPE

(71) Applicant: Noble Rig Holdings Limited, Houston, TX (US)

(72) Inventor: Orlan Lyle, Katy, TX (US)

(21) Appl. No.: 19/636,418

(22) Filed: Apr. 1, 2026

Related U.S. Application Data
(60) Provisional application No. 63/781,601, filed on Apr. 1, 2025.

(51) Int. Cl. F16G 11/08

(52) U.S. Cl. CPC F16G 11/08

(57) ABSTRACT

A connector for wire rope or cable has first and second terminations each coupled at one longitudinal end to a flexible coupling. The first and second terminations and the flexible coupling have a diameter at most equal to a diameter of the wire rope or coupling. The first and second terminations are rotatable with reference to a longitudinal axis of the connector. Each termination comprises a feature for attaching the termination to a respective end of a segment of the wire rope or cable.

### CROSS REFERENCE TO RELATED APPLICATIONS

Priority is claimed from US Provisional Application No. 63/781,601 filed Apr. 1, 2025.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of cables and wire ropes. More specifically, the disclosure relates to couplings used to thread a wire rope or cable through pulleys or sheaves to replace an existing wire rope or cable in a system comprising such pulleys and/or sheaves.

Wire rope or cable is used for, among other purposes, lifting loads such as by a crane, or by hoist unit of a well drilling rig. A winch or similar device may be used to spool and unspool the cable or wire rope to change its length to perform the load lifting. The wire rope or cable may extend through various pulleys or sheaves in order to convert rotary motion of the winch to load movement in a desired direction, e.g., vertically. Moreover, pulleys or sheaves may be arranged to enable larger load to be moved with less torque exerted by the winch by the mechanical advantage of multiple pulleys through which the cable or wire rope passes.

When it becomes necessary to replace the cable or wire rope used in such devices, it is known in the art to thread new cable or wire rope by attaching a free end of the new wire rope or cable to an end of the existing wire rope or cable (which passes through the sheaves or pulleys), and by withdrawing the existing wire rope or cable, thus thread the new wire rope or cable through the sheaves or pulleys.

To perform such threading, it is desirable for the connection between the existing wire rope or cable, in addition to having the required axial strength, to present as small as practical a diameter increase above the diameter of the wire rope or cable and to be flexible to enable passage of the connection around the sheaves or pulleys. Connections known in the art include crimp on connectors, however such crimp on connectors may be impractical for larger diameter wire rope or cable.

There is a need for a wire rope or cable connector that presents limited, if any increase in diameter over the diameter of the wire rope or cable segments to be joined, and is sufficiently flexible to pass through pulleys or sheaves.

### SUMMARY

One aspect of the present disclosure is a connector for wire rope or cable. A connector according to this aspect has first and second terminations each coupled at one longitudinal end to a flexible coupling. The first and second terminations and the flexible coupling have a diameter at most equal to a diameter of the wire rope or coupling. The first and second terminations are rotatable with reference to a longitudinal axis of the connector. Each termination comprises a feature for attaching the termination to a respective end of a segment of the wire rope or cable.

In some implementations, the flexible coupling comprises a universal joint.

In some implementations, the feature on each termination comprises a chisel shaped end.

Some implementations further comprise an alignment fixture to maintain axial alignment of the end of at least one segment of wire rope or cable and axial alignment of the flexible coupling.

In some implementations, the alignment fixture comprises a tube having at least two, hingedly coupled tube segments, each of the at least two tube segments comprising locking loops, and an alignment arm pivotally coupled to one of the at least two tube segments in axial alignment with the one of the at least two tube segments, the alignment arm comprising a magnet to hold the connector in axial alignment with the alignment fixture, the alignment fixture comprising a locking pin insertable through the locking loops to hold the tube segments closed.

A method for joining cable segments together according to another aspect of this disclosure includes disposing a connector between ends of two cable segments. The connector comprises first and second terminations each coupled at one longitudinal end to a flexible coupling. The first and second terminations and the flexible coupling have diameter at most equal to a diameter of the wire rope or coupling. The first and second terminations are rotatable with reference to a longitudinal axis of the connector and wherein each termination comprises a feature for attaching the termination to a respective end of a segment of the wire rope or cable. Each cable segment is welded to one of the first and second terminations.

In some implementations, the flexible coupling comprises a universal joint.

In some implementations, the feature on each termination comprises a chisel shaped end.

Some implementations comprise axially aligning at least one cable end with the connector, by attaching an alignment fixture to at least one cable end.

In some implementations, the alignment fixture comprises a tube having at least two, hingedly coupled tube segments, each of the at least two tube segments comprising locking loops, and an alignment arm pivotally coupled to one of the at least two tube segments in axial alignment with the one of the at least two tube segments, the alignment arm comprising a magnet to hold the connector in axial alignment with the alignment fixture, the alignment fixture comprising a locking pin insertable through the locking loops to hold the tube segments closed.

Other aspects and possible advantages will be apparent from the description and claims that follow.

### BRIEF DESCRIPTION OF THE DRAWINGS

FIG. 1 shows an oblique view of an example implementation of a cable connector according to the present disclosure wherein an alignment fixture is clamped on to a cable segment end in preparation for welding the connector to ends of separate wire ropes or cables.

FIG. 2 shows a cross-sectional view of the example connector of FIG. 1.

FIG. 3 shows an exploded view of the example connector of FIG. 1.

FIGS. 4, 5 and 6 show views corresponding to those of FIGS. 1, 2 and 3, respectively at different viewing angles.

FIG. 7 shows an open view of the alignment fixture to illustrate certain functional components thereof.

### DETAILED DESCRIPTION

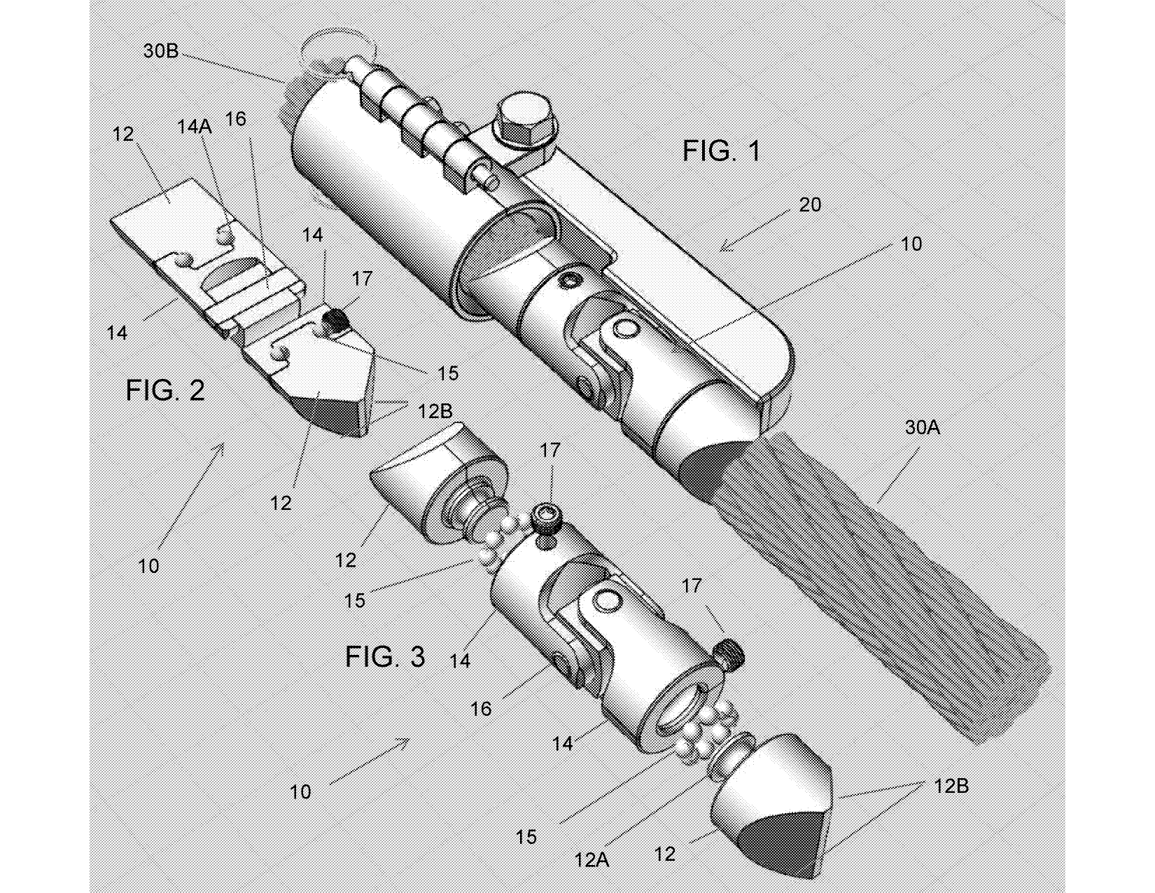

FIGS. 1 and 4 show different views of an example implementation of a connector 10 according to the present disclosure. The connector 10 as shown is in preparation for assembly to a first segment 30A of wire rope or cable and to a second segment 30B of wire rope or cable (hereinafter “cable segment” for convenience). The connector 10 may comprise, as will be explained in more detail below, terminations for coupling the connector 10 to respective ends of the cable segments 30A, 30B. The connector 10 may present an outer diameter at most equal to the diameter of the cable segments 30A, 30B and may comprise a flexible coupling between the terminations to enable the connector 10 to bend or deflect axially, thereby facilitating passage of the connector 10 over pulleys or sheaves. The flexible coupling may enable such axial deflection of one side of the flexible coupling with respect to the other, while enabling transmission of substantial axial loading across the flexible coupling.

For purposes of assembly to the cable segments 30A, 30B, an alignment fixture 20 may be coupled to the first cable segment 30A to hold the first cable segment 30A in axial alignment with the connector 10 during assembly and to hold the connector 10 in axial alignment between the terminations. In some implementations, a corresponding, similar alignment fixture (not shown) may be coupled to the second cable segment 30B in opposed longitudinal direction to maintain axial alignment of both cable segments 30A, 30B with the connector 10.

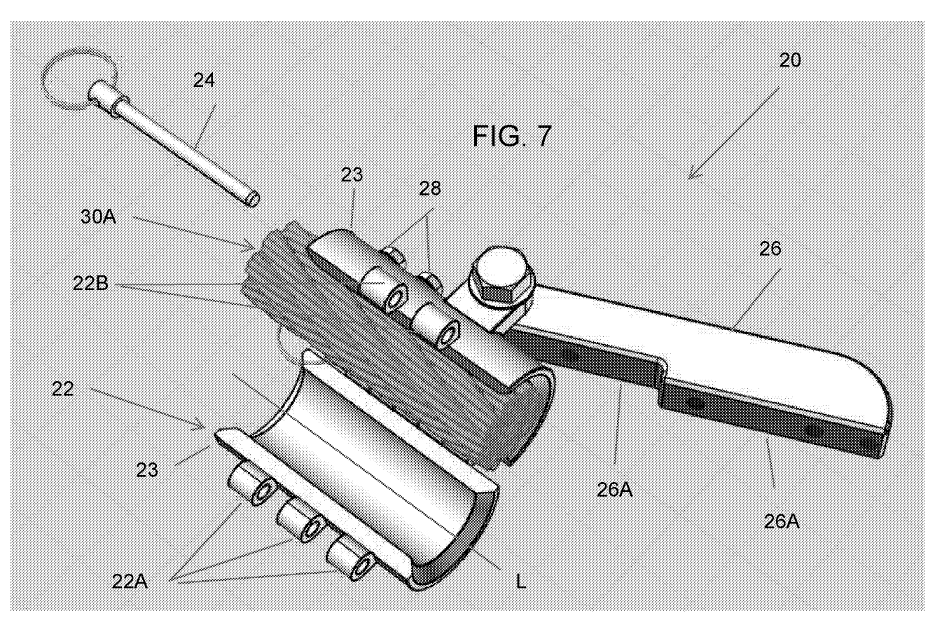

FIGS. 2 and 5 show cross-sectional views of the example implementation of the connector 10. The connector 10 may comprise terminations for coupling the connector 10 to respective cable segment ends. The terminations may comprise swivel receptacles 14 having rotatably connected swivel pins 12 disposed therein. The swivel receptacles 14 and swivel pins 12 may have a generally cylindrical exterior shape and have a diameter substantially the same as the cable segments (30A, 30B in FIG. 1). The swivel receptacles 14 may be coupled to each other longitudinally through a flexible coupling 16 such as a universal joint, which enables relative axial deflection of one swivel receptacle 14 with respect to the other, while enabling transmission of substantial axial loading. Each swivel receptacle 14 may be rotatably coupled to a respective one of the swivel pins 12. Each swivel pin 12 may be rotatably retained in its respective swivel receptacle 14 by bearing balls 15 loaded into a ball race 12A formed in the swivel pin and a respective ball race 14A formed in an interior of the swivel receptacle 14. The bearing balls 15 may be retained in the respective ball races 12A, 14A by a plug 17. In this way, each swivel pin 12 may be rotatably coupled to its respective swivel receptacle 14 so as to enable relative rotation and support axial loading across the connector 10. Each swivel pin 12 may comprise an end 12B such as a chisel shaped end, to enable coupling to an end of a respective cable segment 30A, 30B such as by welding, e.g., making fillet welds to the respective cable segment end. Other shapes for the ends 12B of the swivel pins 12 may include without limitation, pyramid shaped ends or conically shaped ends. The function of the shape of the ends 12B is to expose a substantial portion of the cross section of the respective cable segments ends, whereby welding the cable ends to the swivel pins has great axial strength.

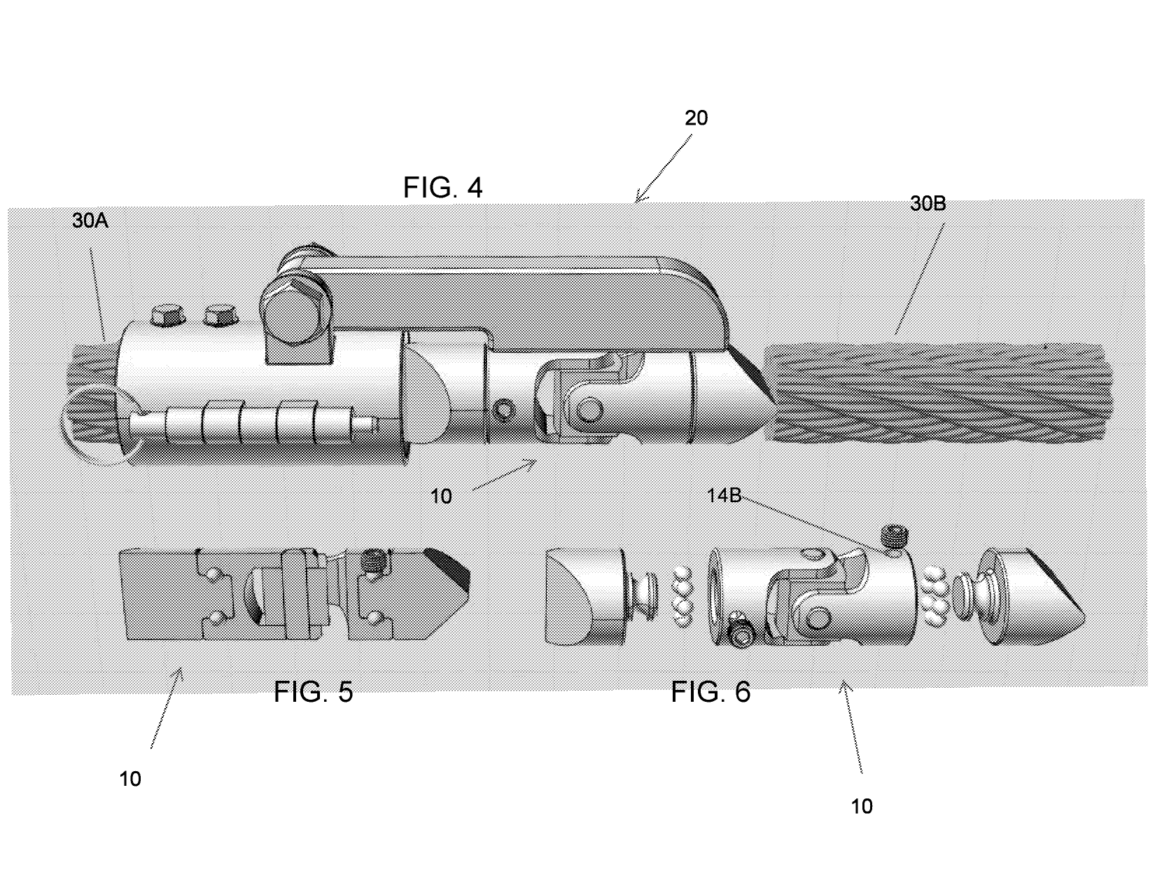

FIGS. 3 and 6 show exploded views of the connector 10 to illustrate assembly of the connector 10 from its component parts. The bearing balls 15 may be loaded into the ball races 12A, 14A through a port 14B in each swivel receptacle 14, wherein the port 17 is closed by the plug 17 after all the bearing balls 15 are so loaded.

The assembled connector 10 may be coupled to the respective ends of the cable segments 30A, 30B such as by welding. During such coupling, it is desirable to hold the cable ends and connector 10 in axial alignment, as explained above. FIG. 7 shows an open view of the alignment fixture 20 as it would be attached to one of the cable segments (e.g., 30A) ends. The alignment fixture 20 may comprise a tube 22 that is longitudinally split into tube sections 23. The tube 22 may have an internal diameter substantially equal to an external diameter of the cable segments 30A, 30B. The tube sections 23 may be hingedly coupled to each other on one circumferential side, parallel to a longitudinal axis L of the tube segments 22, and may comprise corresponding locking loops 22A, 22B on the opposed circumferential side such that the tube 22 may be attached to the cable segment 30A by closing it in “clamshell” manner over the exterior of the cable segment 30A. Once the tube 22 is closed over the cable segment 30A, it may be held closed by a locking pin 24 that is extended through the locking loops 22A, 22B. Set screws 28 may pass through threaded openings (not shown) in one or the other of the tube sections 22 to hold the cable segment 30A in place longitudinally within the alignment fixture 20. The alignment fixture 20 may further comprise an alignment arm 26 pivotally coupled to one of the tube segments 22 parallel to a longitudinal axis of the tube segments 22. The alignment arm 26 has one or more magnets 26A thereon to cause the alignment arm 26 to hold in axial alignment the entire connector (see 10 in FIGS. 1 and 4) during attachment to the cable ends (30A, 30B in FIGS. 1 and 4). After the cable ends are welded to the respective swivel pins (see 12 in FIGS. 2 and 5), the alignment fixture 20 may be removed by pulling out the locking pin 24. It will be appreciated that a second, similar or identical alignment fixture may be coupled to the opposed cable end (see 30B in FIGS. 1 and 4) in the reverse longitudinal direction so that full axial alignment of both cable ends (30A, 30B in FIGS. 1 and 4) may be maintained during assembly of the connector (10 in FIGS. 1 and 4) to the cable ends (30A, 30B in FIGS. 1 and 4). After assembly of the connector 10 to the respective cable ends (30A, 30B in FIGS. 1 and 4) is completed, the alignment fixture(s) 20 may be removed and the new cable (e.g., 30B in FIG. 1) may be pulled through the pulleys or sheaves (not shown) by withdrawing the existing cable, e.g., 30A.

In light of the principles and example implementations described and illustrated herein, it will be recognized that the example implementations can be modified in arrangement and detail without departing from such principles. The foregoing discussion has focused on specific implementations, but other configurations are also contemplated. In particular, even though expressions such as in “an implementation," or the like are used herein, these phrases are meant to generally reference implementation possibilities, and are not intended to limit the disclosure to particular implementation configurations. As used herein, these terms may reference the same or different implementations that are combinable into other implementations. As a rule, any implementation referenced herein is freely combinable with any one or more of the other implementations referenced herein, and any number of features of different implementations are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A connector for wire rope or cable, comprising:
first and second terminations each coupled at one longitudinal end to a flexible coupling, the first and second terminations and the flexible coupling having diameter at most equal to a diameter of the wire rope or coupling, the first and second terminations rotatable with reference to a longitudinal axis of the connector; and
wherein each termination comprises a feature for attaching the termination to a respective end of a segment of the wire rope or cable.

2. The connector of claim 1 wherein the flexible coupling comprises a universal joint.

3. The connector of claim 1 wherein the feature on each termination comprises a chisel shaped end.

4. The connector of claim 1 further comprising an alignment fixture to maintain axial alignment of the end of at least one segment of wire rope or cable and axial alignment of the flexible coupling.

5. The connector of claim 4 wherein the alignment fixture comprises a tube having at least two, hingedly coupled tube segments, each of the at least two tube segments comprising locking loops, and an alignment arm pivotally coupled to one of the at least two tube segments in axial alignment with the one of the at least two tube segments, the alignment arm comprising a magnet to hold the connector in axial alignment with the alignment fixture, the alignment fixture comprising a locking pin insertable through the locking loops to hold the tube segments closed.

6. A method for joining cable segments together, comprising:
disposing a connector between ends of two cable segments, the connector comprising first and second terminations each coupled at one longitudinal end to a flexible coupling, the first and second terminations and the flexible coupling having diameter at most equal to a diameter of the wire rope or coupling, the first and second terminations rotatable with reference to a longitudinal axis of the connector and wherein each termination comprises a feature for attaching the termination to a respective end of a segment of the wire rope or cable; and
welding each cable segment to one of the first and second terminations.

7. The method of claim 6 wherein the flexible coupling comprises a universal joint.

8. The method of claim 6 wherein the feature on each termination comprises a chisel shaped end.

9. The method of claim 6 further comprising axially aligning at least one cable end with the connector, by attaching an alignment fixture to at least one cable end.

10. The method of claim 9 wherein the alignment fixture comprises a tube having at least two, hingedly coupled tube segments, each of the at least two tube segments comprising locking loops, and an alignment arm pivotally coupled to one of the at least two tube segments in axial alignment with the one of the at least two tube segments, the alignment arm comprising a magnet to hold the connector in axial alignment with the alignment fixture, the alignment fixture comprising a locking pin insertable through the locking loops to hold the tube segments closed.
